(19) United States
(12) Patent Application Publication
(10) Pub. No.: US 2013/0187592 A1
(43) Pub. Date: Jul. 25, 2013

(54) ON-SHORE ELECTRICAL CHARGING SYSTEM AND METHOD THEREOF

(71) Applicants: Feng-Yeang Chung, New Taipei City (TW); Ying-Chao Liao, New Taipei City (TW); Hung-Hsi Lin, New Taipei City (TW); Shean-Kwang Chou, New Taipei City (TW)

(72) Inventors: Feng-Yeang Chung, New Taipei City (TW); Ying-Chao Liao, New Taipei City (TW); Hung-Hsi Lin, New Taipei City (TW); Shean-Kwang Chou, New Taipei City (TW)

(73) Assignee: Ship and Ocean Industries R&D Center, New Taipei City (TW)

(21) Appl. No.: 13/400,570

(22) Filed: Feb. 20, 2012

(30) Foreign Application Priority Data
Jan. 20, 2012 (TW) 101102422

(51) Int. Cl. H02J 7/00

(52) U.S. Cl. 320/107; 320/137

(57) ABSTRACT

An on-shore electrical charging system and a method thereof are provided. The on-shore electrical charging system for vessels includes an on-shore electrical charging apparatus and a management platform. The electrical charging apparatus includes at least one digital watt hour meter, an identification apparatus, an electromagnetic lock, an emergency switch, a charge management module, and at least one plug. The method of on-shore electrical charging allows a vessel charge record to be sent to the management platform, so that users and system managers can obtain and management information such as charge status and charge amount.

### BACKGROUND OF THE INVENTION

1. Field of the Invention

The invention relates in general to an electrical charging system and method thereof, and more particularly to an on-shore electrical charging system and method thereof.

2. Description of the Related Art

Green industry activities are continuously encouraged by various fields in the hope that an original efficiency can be achieved while reducing emitted pollutions. Domestically in Sun Moon Lake, promotions of electric vessels have been launched, and so the vessels are additionally equipped with pure electric power that together with original power generators perform hybrid power operations. To supplement resources for the pure electric power, alternating current (AC) charging columns are required on shore to provide the vessels with electric power supply.

A conventional charging device is mainly tailored for charging electric vehicles and thus may not be meet all requirements of electric vessels. Further, a conventional charging device is capable of charging electric vehicles but lacks functions of charging management. Also, in the absence of means for connecting to a management platform, a conventional on-shore charging device cannot be managed by a centralized management control center for management activities including general management as well as data collection and analysis.

### SUMMARY OF THE INVENTION

The invention is directed to an on-shore electrical charging system and method thereof. Apart from providing a charging hardware device for vessels, the invention further provides a management module for managing a charging process and charging information. The on-shore electrical charging system for vessels comprises an electrical charging apparatus and a management platform. The on-shore electrical charging device comprises at least one digital watt hour meter, an identification apparatus, an electromagnetic lock, an emergency switch, a charge management module, and at least one plug. The at least one digital watt hour meter, the identification apparatus, the emergency switch are respectively connected to the charge management module. The at least one plug is connected to a vessel electrical charger, which accordingly charges a battery set on the vessel. The on-shore electrical charging device for vessels may be provided with a cover. The cover covers the at least one digital watt hour meter, the identification apparatus, the emergency switch and the charge management module, and is locked by the electromagnetic lock to prevent unauthorized and undesired contact and use of the on-shore electrical charging apparatus for vessels of the present invention.

The charge management module controls a charging process of the on-shore electrical charging system for vessels. The method of charging management comprises: activating a charge management module, verifying a user identification, unlocking the cover, setting an output mode, starting to charge or disconnecting power supply, determining whether to activate the emergency switch, connecting the plug, outputting power supply to a vessel electrical charger, logging out the user identification, and locking the cover.

The power supply for the on-shore electrical charging system for vessels may be from a market electricity system and/or a power generating system. The management platform of the on-shore electrical charging system for vessels comprises a charge information inquiry module, a charge information collecting module, a charge information processing module, and a charge information database. The charge information processing module is connected to the charge information inquiry module and the charge information collecting module, and requests charge information from the charge management module via the charge information inquiry module and the charge information collecting module. The charge information database is connected to the charge information processing module. The charge information processing module categorizes obtained charge information and establishes a charge archive that is stored in the charge information database for future user search and access.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of an on-shore electrical charging system for vessels according to an embodiment of the present invention.

FIG. 2 is a flowchart of a method performed by an on-shore charge system for vessels of the present invention.

FIG. 3 is another flowchart of a method performed by an on-shore charge system for vessels of the present invention.

### DETAILED DESCRIPTION OF THE INVENTION

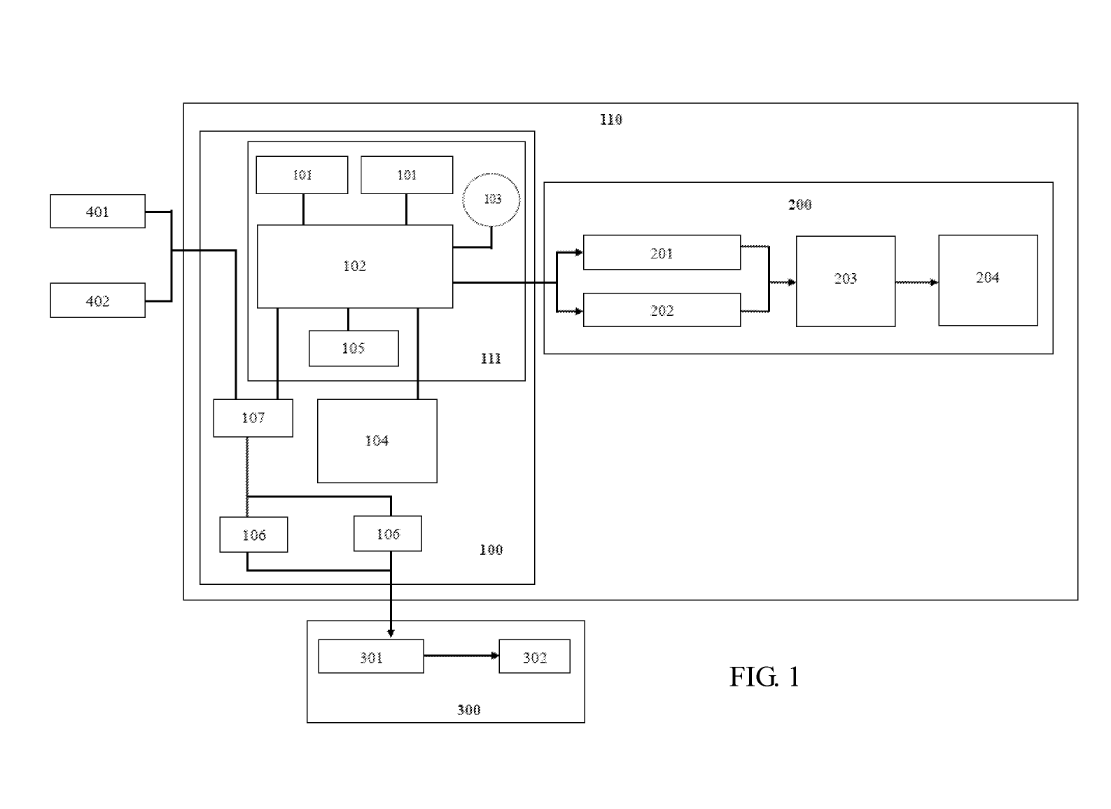

Referring to FIG. 1, an on-shore electrical charging system for vessels 110 according to an embodiment comprises an on-shore electrical charging device for vessels 100 and a management platform 200. The on-shore electrical charging device for vessels 100 at least one digital watt hour meter 101, a charge management module 102, an emergency switch 103, an identification apparatus 104, an electromagnetic lock 105 and at least one plug 106. The at least one digital watt hour meter 101, the emergency switch 103, the identification apparatus 104 and the electromagnetic lock 105 are respectively connected to the charge management module 102. The at least one plug 106, connected to a vessel electrical charger 301, is connected to a market electricity system 401 and/or a power generating system 402 to provide power to the vessel electrical charger 301. The vessel electrical charger 301 then is allowed to charge a battery set 302 disposed on an electric vessel 300.

In this embodiment, for example, the charge management module 102 is a touch control industrial computer that is operated through a touch display. Thus, a hardware configuration may be simplified while also satisfying a crucial requirement of high space efficiency for vessels. Further, to increase utilization security, the at least one plug 106 may be an interlocking plug.

The identification apparatus 104 verifies a user identification. For example, the identification apparatus 104 is a digital, electronic, biological and/or mechanical identification apparatus. For example, the identification apparatus 104 is capable of identifying radio frequency identification (RFID) systems, quick response codes (QR-code), fingerprints, keys, numbers, voiceprints and/or facial features. Only with a valid verification license obtained from the identification apparatus 104 through a verification medium possessed by a user, a user is allowed to use the on-shore electrical charge system for vessels 110.

The on-shore electrical charging system for vessels 110 of the present invention may further comprise a cover 111. The cover 111 covers the at least watt meter 101, the emergency switch 103 and the charge management module 102. By locking the cover 111 with the electromagnetic lock 105, not only unauthorized contact of the on-shore electrical charging system for vessels 110 is obviated, but equipment or personnel damages resulted by a third person accidentally engaging the present invention are also prevented.

The on-shore electrical charging apparatus for system 110 of the present invention may be connected to a market electricity system 401 and/or a power generating system 402, to provide a power supply for charging. For example, the market electricity system 401 is a power network system established by a local government or by a private power company; the power system 402 is a power generating device such as a gasoline power generator, a diesel power generator or a fuel battery.

The charge management module 102 is connected to the management platform 200 and transmits charge-related information to the management platform 200, so as to allow the management platform 200 to effectively manage the on-shore electrical charge apparatus for vessels 100 from a remote end. The management platform 200, being capable of managing at least one connected on-shore electrical charging apparatus for vessels 100, comprises a charge information inquiry module 201, a charge information collecting module 202, a charge information processing module 203, and a charge information database 204. The charge information processing module 203 is connected to the charge information inquiry module 201, the charge information collecting module 202, and the charge information database 204.

After the charge management module 102 is activated, charging information may be transmitted between the charge management module 102 and the management platform 200 via the Internet on a periodical or manual basis. The charge information includes a user identification, a charge time, a disconnection time, and/or an amount of outputted power supply.

According to an embodiment, a method performed by the charge management module 102 comprises: activating the charge management module (Step 501), verifying a user identification (Step 502), unlocking the cover (Step 503), setting an output mode (Step 504), determining whether to activate the emergency stop switch (Step 508), connecting the plug (Step 509), outputting power supply to the vessel electrical charger (Step 510), disconnecting power as an emergency (Step 511), logging out the user identification (Step 512), and locking the cover (Step 513).

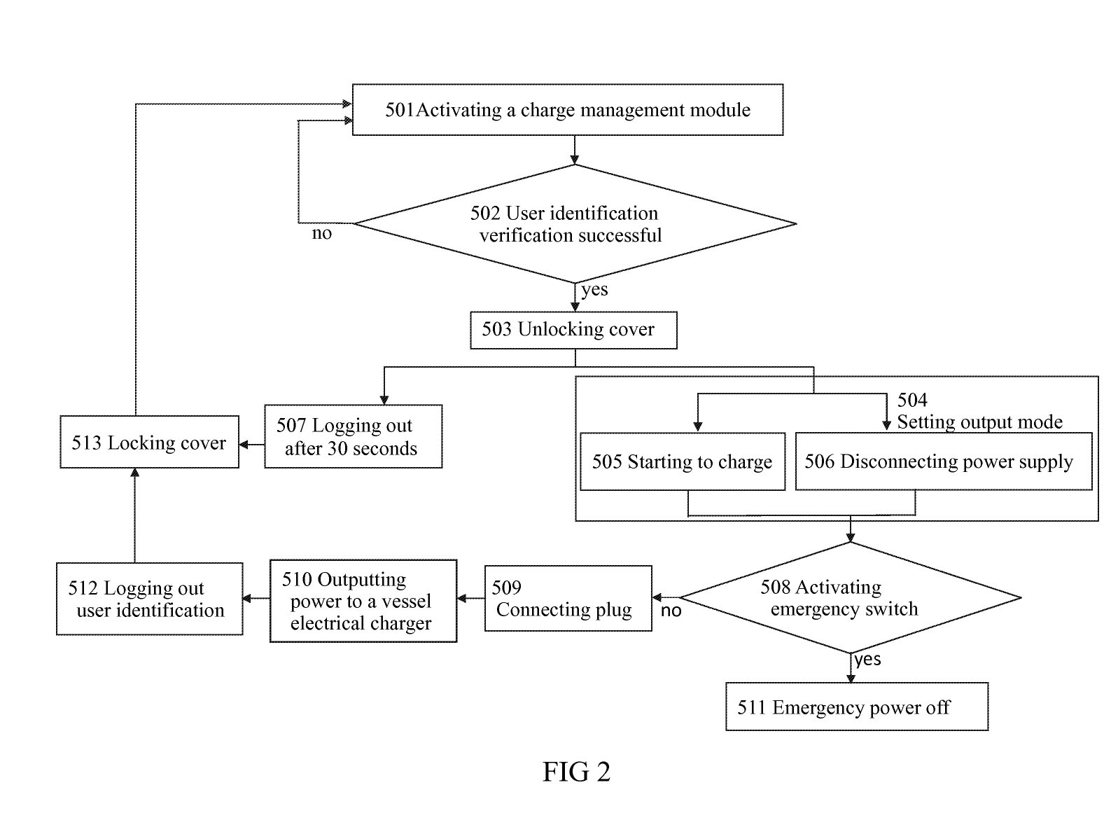

Referring to FIG. 2, the charge management module is activated in Step 501, and the user identification is verified through a verification medium possessed by the user in Step 502. Step 503 is performed if the verification in Step 502 is successful to unlock the cover, or else the method iterates Step 501 if the verification is failed. After unlocking the lock, Step 504 is performed in which the user selects either starting to charge as Step 505 or disconnecting power supply as Step 506. In the event that no command is received from the user after 30 seconds or after a predetermined period, the charge management module 102 logs out in Step 507. In Step 513, the cover is locked, and the method returns to Step 502 to perform the user identification verification step. After performing either Step 505 of starting to charge or Step 506 of disconnecting power supply, it is determined whether to activate the emergency stop switch in Step 508. If the emergency stop switch is not activated, the plug is connected in Step 509, followed by outputting power supply to the vessel charger in Step 510. When charging is completed, Step 512 is performed to log out the user identification and Step 513 is performed to lock the cover. The charge management module 102 then returns to Step 502 for the user identification verification step. If the emergency stop switch is activated, the charge management module 102 sequentially performs Step 511 to disconnect the power as an emergency, Step 512 to log out the user identification, and Step 513 to lock the cover, and then returns to Step 502 of the user identification verification.

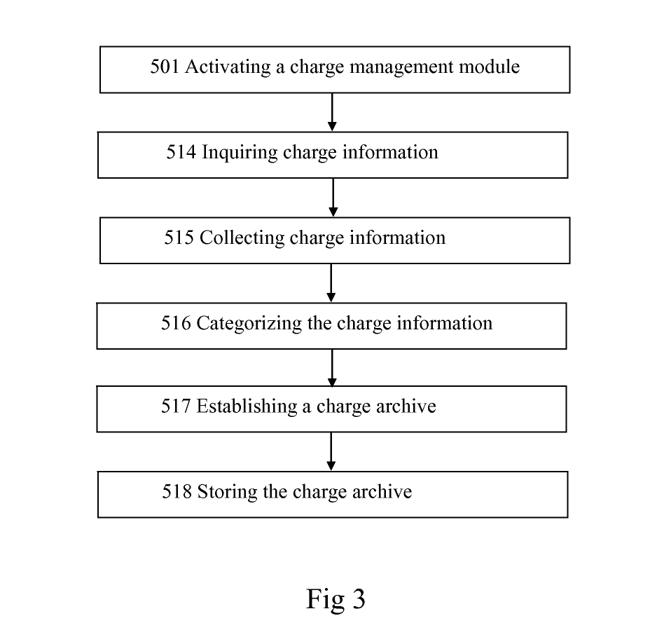

FIG. 3 shows another operating method of the on-shore electrical charging system of the present invention. After activating a charge management module in Step 501, the management platform performs steps of: inquiring charge information (Step 514), collecting the charge information (Step 515), categorizing the charge information (Step 516), establishing a charge archive (Step 517), and storing the a charge archive (Step 518).

Referring to FIG. 3, in Step 501, a charge management module is activated. In Step 514, charge information is inquired according to a user identification. In Step 515, via the Internet, the charge information is collected on a periodical or manual basis. In Step 516, the collected charge information is compiled or categorized. In Step 517, a charge archive is established. In Step 518, the charge archive is stored.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An on-shore electrical charging system for vessels, comprising an on-shore electrical charging apparatus for vessels, wherein the on-shore electrical charging apparatus for vessels comprises:
at least one digital watt hour meter;
an identification apparatus;
an electromagnetic lock;
an emergency switch; and
at least one plug, connected to a vessel electrical charger;
wherein, the at least one digital watt hour meter, the identification apparatus, the electromagnetic lock and the emergency switch are respectively a charge management module.

2. The system according to claim 1, wherein the charge management module is a touch control industrial computer.

3. The system according to claim 1, wherein the at least plug is an interlocking plug.

4. The system according to claim 1, wherein the identification apparatus is a digital, electronic, biological and/or mechanical identification apparatus.

5. The system according to claim 4, wherein the identification apparatus is capable of identifying RFID systems, QR-codes, fingerprints, keys, numbers, voiceprints and/or facial features.

6. The system according to claim 1, further comprising:
a cover, being locked by the electromagnetic lock, for covering the at least one digital watt hour meter, the emergency switch and the charge management module.

7. The system according to claim 1, being connected to a market electricity system and/or a power generator system.

8. The system according to claim 1, further comprising a management platform.

9. The system according to claim 8, wherein charge information is transmitted between the charge management module and the management platform via the Internet on a periodical or manual basis.

10. The system according to claim 9, wherein the charge information comprises a user identification, a charge time, a power disconnection time, and/or an amount of outputted power supply.

11. The system according to claim 10, wherein the management platform comprises:
a charge information inquiry module;
a charge information collecting module;
a charge information processing module, connected to the charge information inquiry module and the charge information collecting module; and
a charge information database, connected to the charge information processing module.

12. A method of an on-shore electrical charge system for vessels, comprising:
activating a charge management module;
verifying a user identification;
unlocking a cover;
setting an output mode;
determining whether to activate an emergency stop switch;
connecting a plug;
outputting power supply to a vessel electrical charger;
logging out the user identification; and
locking the cover.

13. The method according to claim 12, wherein when no command is received after the step of unlocking the cover, the charge management module automatically logs out the user identification and locks the cover.

14. The method according to claim 12, further comprising starting to charge or disconnecting power supply after the step of setting the output mode.

15. The method according to claim 13, wherein when it is determined to activate the emergency stop switch in the determining step, power is disconnected as an emergency, the charge management module automatically logs out the user identification and locks the cover.

16. A method of an on-shore electrical charge system for vessels, comprising:
activating a charge management module;
inquiring and collecting charge information;
categorizing the charge information;
establishing a charge archive; and
storing the charge archive.
